(19) United States
(12) Patent Application Publication
(10) Pub. No.: US 2026/0236222 A1
(43) Pub. Date: Aug. 13, 2026

(54) DETECTING DESIGN COMMMANDS FROM SPEECH USING NATURAL LANGUAGE PROCESSING TO GENERATE DESIGN VARIATIONS

(71) Applicant: ADOBE INC., San Jose, CA (US)

(72) Inventors: Samine HADADI, Sydney (AU); Dan-Gabriel GHITA, Bucharest (RO); Zoran NIKOLOVSKI, Melbourne (AU)

(21) Appl. No.: 19/052,942

(22) Filed: Feb. 13, 2025

(30) Foreign Application Priority Data
Feb. 13, 2025 (RO) A/10007/2025

(51) Int. Cl. G06F 3/16; G06F 40/205; G06T 11/60

(52) U.S. Cl. CPC G06F 3/167; G06F 40/205; G06T 11/60

(57) ABSTRACT

Methods and systems are provided for detecting design commands from speech using natural language processing to generate design variations. In embodiments described herein, a user inputs speech indicating a desired design. Parameters of detected design commands mapped to particular design tools of a design application are detected from input speech. Design variations are generated based on the detected parameters of the detected design commands by applying the corresponding design tools. The user inputs subsequent speech indicating desired revisions to the design variations. Different parameters of detected design commands mapped to particular design tools of the design application are detected from the subsequent speech. New design variations are generated based on the detected different parameters by applying the corresponding design tools to the design variations. After the user reviews the new design variations, the design process iteratively continues until the user selects a final design.

### CROSS REFERENCE TO RELATED APPLICATIONS

This application claims the benefit of priority to Romanian Patent Application No. A/10007/2025 filed on Feb. 13, 2025, the entire contents of which are incorporated by reference herein in their entirety.

### BACKGROUND

Graphic design is the practice of creating visual content to communicate messages and ideas effectively. For example, a graphic designer may create design content for marketing that is visually appealing in order to effectively communicate a brand's message and engage with a target audience. The design process is often iterative as a graphic designer will begin with an initial design and iteratively refine the design through incremental adjustments until achieving a final design. Design applications provide various tools to optimize the design process to assist the graphic designer to generate an initial design and make incremental adjustments to the design. However, as the complexity of the design application interface increases due to the number of available features, certain devices or users are unable to utilize the features of the design application due to interface constraints or accessibility constraints.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, detecting design commands from speech using natural language processing (NLP) to generate design variations. For example, a user inputs speech, such through a microphone on a user device, indicating a desired design. A design command detection engine detects parameters of detected design commands mapped to particular design tools of a design application from a prompt generated based on the speech. Design variation generation engine generates design variations that comply with the detected parameters of the detected design commands from the prompt, such as design variations with different layouts, color schemes, content arrangements, and/or the like. The user inputs subsequent speech indicating desired revisions to the design variations, such as a selection of particular parameters of the design variations and desired revisions to the design variations. The design command detection engine detects parameters of detected design commands mapped to particular design tools of the design application from a subsequent prompt generated based on the subsequent speech. Design variation generation engine generates new design variations based on the design variations that comply with the detected parameters of the detected design commands from the subsequent prompt. After the user reviews the new design variations, the design process iteratively continues until the user selects a final design.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 provides an example diagram of facilitating detecting design commands from speech using NLP to generate design variations, in accordance with embodiments of the present disclosure.

FIG. 4 provides an example design application interface with text converted from input speech, in accordance with embodiments of the present disclosure.

FIG. 5 provides an example design application interface with generated design variations based on the text converted from input speech of FIG. 4, in accordance with embodiments of the present disclosure.

FIG. 6 provides an example design application interface with text converted from subsequent input speech based on the generated design variations of FIG. 5, in accordance with embodiments of the present disclosure.

FIG. 7 provides an example design application interface with generated design variations based on the text converted from the subsequent input speech of FIG. 6, in accordance with embodiments of the present disclosure.

FIG. 8 is a process flow showing a method for facilitating detecting design commands from speech using NLP to generate design variations, in accordance with embodiments of the present disclosure.

FIG. 9 is a process flow showing a method for facilitating detecting design commands from speech using NLP to generate design variations, in accordance with embodiments of the present disclosure.

FIG. 10 is a block diagram of an example computing device in which embodiments of the present disclosure can be employed.

### DETAILED DESCRIPTION

### Definitions

Various terms are used throughout the description of embodiments provided herein. A brief overview of such terms and phrases is provided here for ease of understanding, but more details of these terms and phrases is provided throughout.
A “design application” generally refers to a software program that enables users, such as graphic designers, to create, edit, and manage visual content. Design applications include various features, referred to herein as “design tools,” that assists users in creating, editing, and managing visual content. The design tools are typically accessed by selecting a particular widget on the user interface of the design application. The user can then select and/or enter particular parameters into the design tool to edit the design. Examples of design tools include a template selection design tool, a typography selection design tool, a color scheme selection design tool, elements or images selection design tool, a shape creation design tool, a filter design tool, an image resizing design tool, a text-to-template design tool that uses generative artificial intelligence (AI) to create editable templates (e.g., social media posts, flyers, posters, cards, and/or the like) based on a text description provided by the user, a text-to-image design tool that uses generative AI to create images based on a text description provided by the user, a text design tool for adding and formatting text, and/or the like.
A “design command” or “design action” generally refers to an action initiated by a user using a particular design tool in a design application to perform a specific operation to edit a design based on selected parameters. For example, design commands can include operations, such as an operation to select a particular template (e.g., a social media post template, a flyer template, a poster template and a card template, and/or the like) via a template selection design tool, an operation to select a particular typography (e.g., a layout, a typeface, a font, font, a font, a fill, and/or the like) via a typography selection design tool, an operation to select a particular color scheme via a color scheme selection design tool, an operation to select a particular set of elements or images via an elements or images selection design tool, an operation to create a particular shape via a shape creation design tool, an operation to apply a particular filter via a filter design tool, an operation to resize an image to a particular size via an image resizing design tool, an operation to apply a particular prompt to generate a template via a text-to-template design tool, an operation to apply a particular prompt to generate an image via a text-to-image design tool, an operation to apply particular edits to text via a text design tool, and/or the like.
A “design variation” generally refers to a variation of a design generated based on a specific combination of parameters of design commands of design tools within a design application. For example, design variations can be generated that meet the selected parameters of the selected design commands that each include a different combination of parameters of design commands of design tools, such parameters corresponding to alternative styles, layouts, or features. For example, a user may generate a design for particular content, but did not specify the particular color scheme for the design. In this regard, design variations for the design may include different color schemes.

### Overview

As discussed above, design applications provide various tools to optimize the design process to assist the graphic designer to generate an initial design and make incremental adjustments to the design. However, as the complexity of the design application interface increases due to the number of available design tools, certain devices or users are unable to utilize the design tools of the design application. For example, small devices, such as mobile devices, cannot navigate a complex design application interface due to the size of the screen or input certain design actions, such as design actions that require a mouse. Similarly, users with disabilities and the aging population encounter issues with complex design application interfaces and inputting certain design actions, thereby limiting the productivity and creative potential of those users. As yet another example, novice users often feel overwhelmed by a complex design application interface with a large number of available tools, thereby hindering the efficiency of novice users.

Accordingly, unnecessary computing resources are utilized by individuals that are unable to use tools of a design application that optimize the design process in conventional implementations. For example, computing and network resources are unnecessarily consumed to facilitate manually generating and refining of a design without the use of tools that optimize the design process (e.g., as certain individuals are unable to use the tools or certain devices are unable to display the tools). For instance, computer input/output operations are unnecessarily increased in order to manually generate and refine a design as each manual editing operation performed by the individual increases the number of input/output operations. Further, when information related to the design is located in a disk array, there is unnecessary wear placed on the read/write head of the disk of the disk array to manually generate and refine the design. Even further, when information related to the design is located over a network, the processing of operations to manually generate and refine the design decreases the throughput for a network, increases the network latency, and increases packet generation costs.

As such, embodiments of the present disclosure are directed to detecting design commands from speech using NLP to generate design variations in an efficient and effective manner. In this regard, initial design variations can be generated based on design commands and corresponding parameters detected from speech. Subsequently, new design variations can be iteratively generated from the initial design variations based on changes to the parameters of the initial design variations that are detected from subsequent speech.

Generally, and at a high level, embodiments described herein facilitate detecting design commands from speech using NLP to generate design variations. For example, a user inputs speech, such through a microphone on a user device, indicating a desired design. A design command detection engine detects parameters of detected design commands mapped to particular design tools of a design application from a prompt generated based on the speech. Design variation generation engine generates design variations that comply with the detected parameters of the detected design commands from the prompt, such as design variations with different layouts, color schemes, content arrangements, and/or the like. The user inputs subsequent speech indicating desired revisions to the design variations, such as a selection of particular parameters of the design variations and desired revisions to the design variations. The design command detection engine detects parameters of detected design commands mapped to particular design tools of the design application from a subsequent prompt generated based on the subsequent speech. Design variation generation engine generates new design variations based on the design variations that comply with the detected parameters of the detected design commands from the subsequent prompt. After the user reviews the new design variations, the design process iteratively continues until the user selects a final design.

In operation, a user, such as a graphic designer, inputs speech, such through a microphone on the user device, indicating a desired design. For example, a user initiates a new design, such as by selecting a new project. The user then provides voice commands to specify the desired design. In some embodiments, the user also inputs content, such as previous designs, images or documents, to assist in generating the desired design.

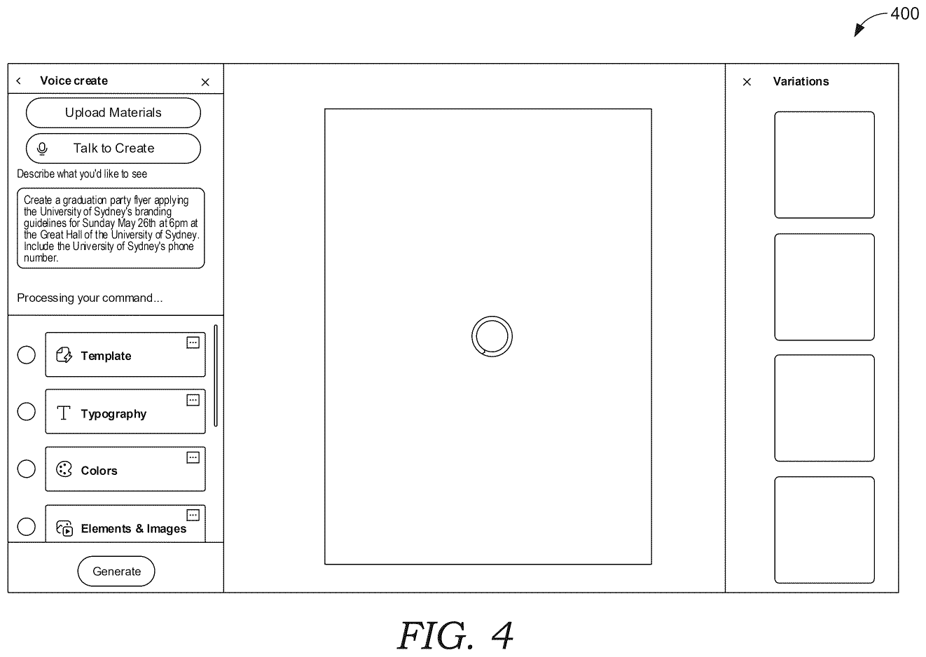

The speech is accessed by a speech input accessing engine. For example, the speech input accessing engine implements voice capturing through an application programming interface (API), such as Web Audio API, web real-time communication (WebRTC) API, and/or the like. In certain embodiments, the speech is then converted to text by input processing engine. An example of text that is converted from input speech is shown in design application interface 400 of FIG. 4.

An input processing engine generates a prompt based on the input speech, input content (e.g., previous designs, input supporting materials, and/or the like), and/or any preset specifications, such as branding guidelines of a business. For example, input processing engine processes the input speech, input content, and/or any preset specifications using a contextual layer that understands the user's design context by leveraging NLP and semantic understanding in order to generate a prompt that sets the context for the design task.

A design command detection engine detects parameters of detected design commands mapped to particular design tools of a design application from the prompt (e.g., based on the input speech, input content, and/or any preset specifications). In certain embodiments, design command detection engine can detect design commands mapped to particular design tools of a design application, such as a template selection design command mapped to a template selection design tool of a design application, a text design command mapped to a text design tool of a design application, a content design command mapped to a content design tool of a design application, such as an image selection design command mapped to an image selection design tool of a design application, a text-to-image design command mapped to a text-to-image design tool of a design application and/or the like, and/or any design command mapped to a particular design tool of a design application.

Based on each detected design command in the prompt, design command detection engine detects parameters of each detected design command from the prompt. For example, with respect to a detected template selection design command, design command detection engine can detect a parameter indicating the particular type of template, a parameter indicating a particular color scheme for the template, and/or the like from the input speech, input content, and/or preset specifications. In certain embodiments, a design command detection engine detects parameters of detected design commands mapped to particular design tools of a design application from a prompt using an ontological model that maps terminology to particular design tools.

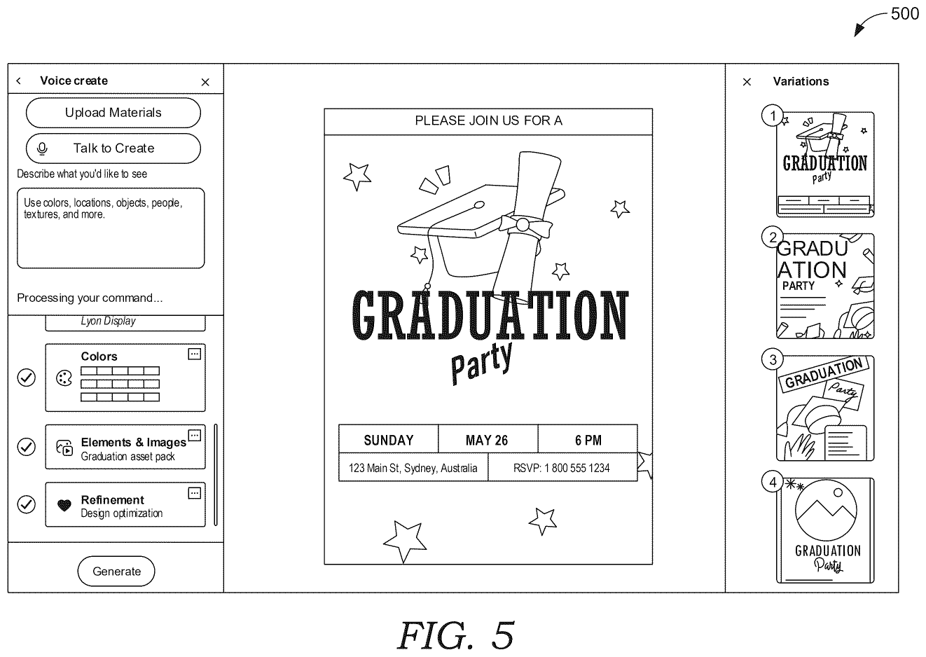

Design variation generation engine generates design variations based on the detected parameters of the detected design commands. The design variation generation engine causes each corresponding design tool of the detected design commands to apply the detected parameters of the detected design commands to the design variations via a design tool accessing engine. In certain embodiments, the design variation generation is a rule-based engine that generates different design variations that comply with the detected parameters of the detected design commands by generating design variations with different layouts, color schemes, content arrangements, and/or the like. An example of design variations generated based on the detected parameters of the detected design commands is shown in design application interface 500 of FIG. 5.

After reviewing the design variations via the design application, the user inputs subsequent speech indicating desired revisions to the design variations. In this regard, the user can provide additional instructions to iteratively tweak or remix the existing variations to adjust elements, such as color, layout, and/or content in order to regenerate new design variations until a desired result is achieved. In certain embodiments, the user inputs subsequent speech indicating a selection of particular parameters of the design variations and desired revisions to the design variations in order to generate new design variations. For example, a user may input speech selecting a particular design variation and desired changes to the selected design variation in order to generate new design variations. As another example, a user may input speech selecting parameters of the design variations, such as a first parameter of one design variation and a second parameter of a different one of the design variations, in order to generate new design variations.

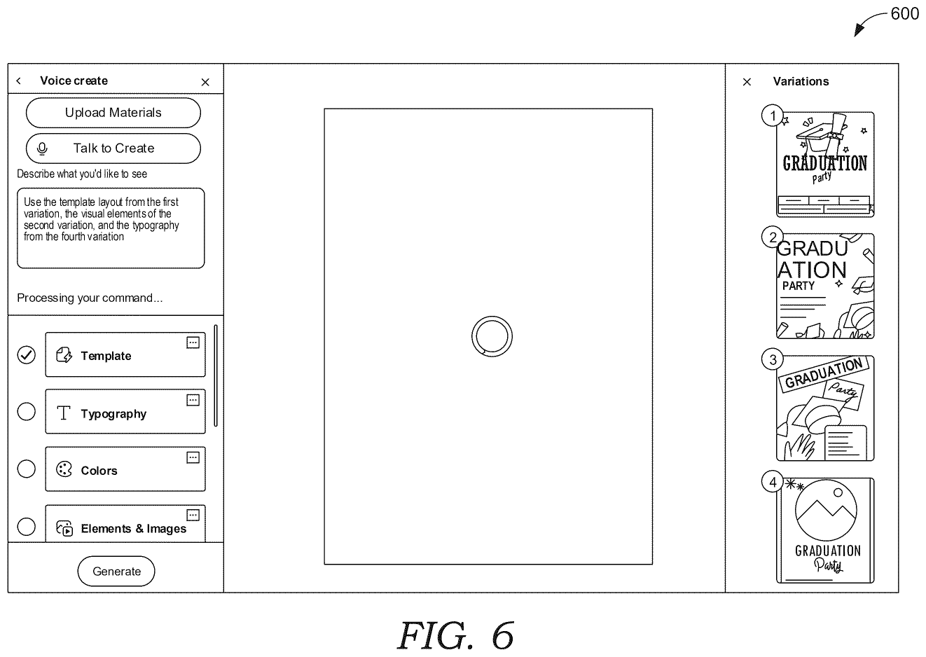

The subsequent speech is accessed by a speech input accessing engine and converted to text by input processing engine. An example of text that is converted from input speech is shown in design application interface 600 of a user device of FIG. 6. Input processing engine generates a subsequent prompt based on the subsequent speech, the design variations, the input content, and/or any preset specifications. In certain embodiments, design command detection engine detects parameters of detected design commands mapped to particular design tools of the design application from the subsequent prompt. For example, the design command detection engine detects a design command to select a particular design variation and parameters of design commands corresponding to the desired changes to the selected design variation. As another example, design command detection engine detects selected parameters of detected design commands from the particular design variations (e.g., and any parameters of design commands corresponding to the desired changes to the selected design variation).

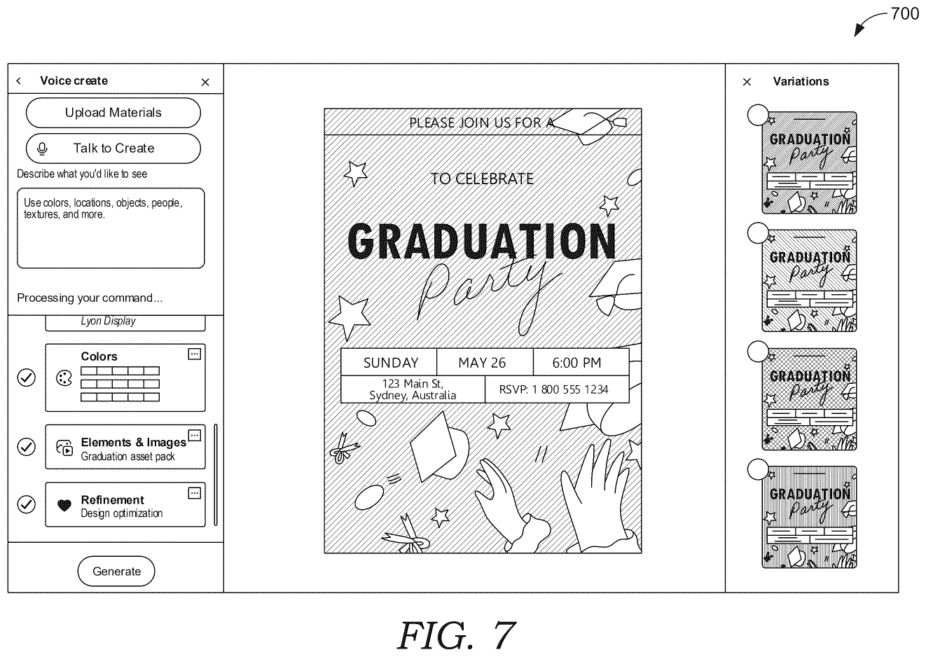

Design variation generation engine generates new design variations based on the detected parameters of the detected design commands from the subsequent prompt. An example of new design variations generated based on detected parameters of detected design commands from a subsequent prompt is shown in design application interface 700 of FIG. 7. In certain embodiments, after the user reviews the new design variations, the design process iteratively continues until the user selects a final design. The user can then finalize and save the design. For example, the user can select or input speech indicating the design variation to save as the finalized design.

In certain embodiments, the previously generated variations and/or any selection of a particular design variation can be used to train input processing engine, design command detection engine, and/or design variation generation engine. For example, input processing engine can be trained for a particular user or a particular brand (e.g., of a business) in order to optimize the generation of the prompt that sets the context for the design task. As another example, design command detection engine can be trained for a particular user or a particular business in order to optimize the semantic understanding of particular design commands. As another example, design variation generation engine can be trained for a particular user or a particular brand (e.g., of a business) in order to optimize the initial output of the generated design variations based on previously selected design variations.

Advantageously, efficiencies of computing and network resources can be enhanced using implementations described herein. In particular, the detecting design commands from speech using NLP to generate design variations results in a more efficient use of computing resources (e.g., higher throughput and reduced latency for a network, less packet generation costs, etc.) than conventional methods of manually generating and refining of a design without the use of tools that optimize the design process (e.g., for individuals that are unable to use the tools due to the complexity of design application interfaces). For example, the technology described herein enables the efficient and effective detection of design commands from speech using NLP to generate design variations, thereby reducing unnecessary computing resources used to process a significant number of manual operations to manually generate and refine a design. Further, the technology described herein results in less manual operations to generate and refine a design over a computer network, which results in higher throughput, reduced latency and less packet generation costs as fewer packets are sent over a network. Therefore, the technology described herein conserves network resources.

### Overview of Exemplary Environments of Detecting Design Commands From Speech Using NLP to Generate Design Variations

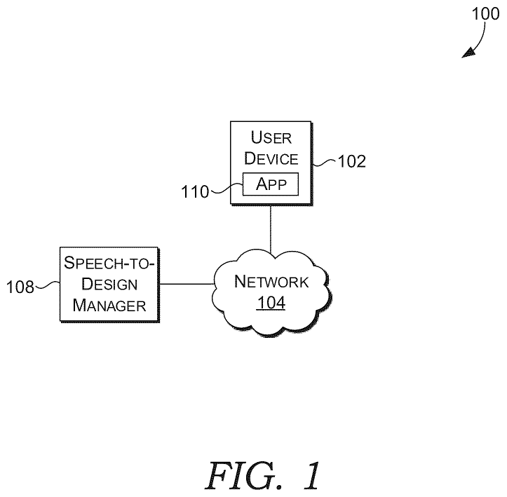

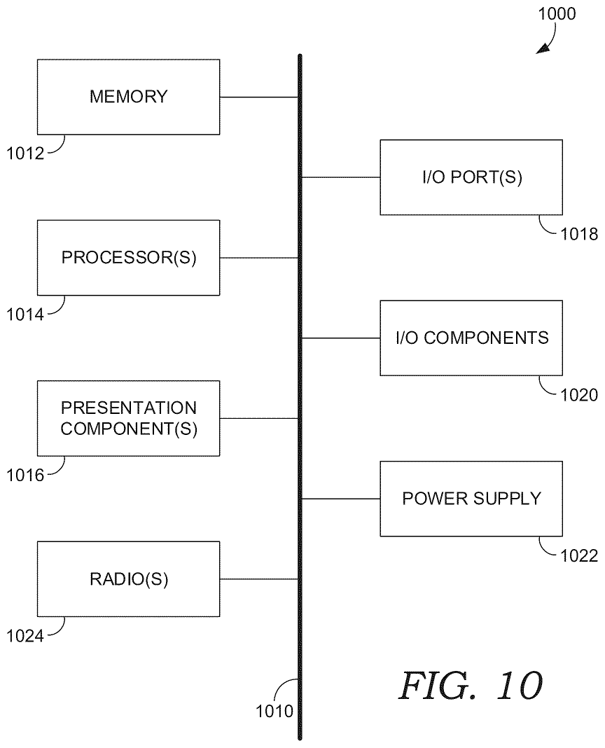

Turning to FIG. 1, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 10.

It should be understood that operating environment 100 shown in FIG. 1 is an example of one suitable operating environment. Among other components not shown, operating environment 100 includes a user device 102, network 104, and speech-to-design manager 108. These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., a graphic designer or any user creating designs). For example, in some implementations, such devices are the type of computing device described in relation to FIG. 10. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

User device 102 can be a client device on a client-side of operating environment 100, while speech-to-design manager 108 can be on a server-side of operating environment 100. Speech-to-design manager 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or speech-to-design manager 108 to remain as separate entities.

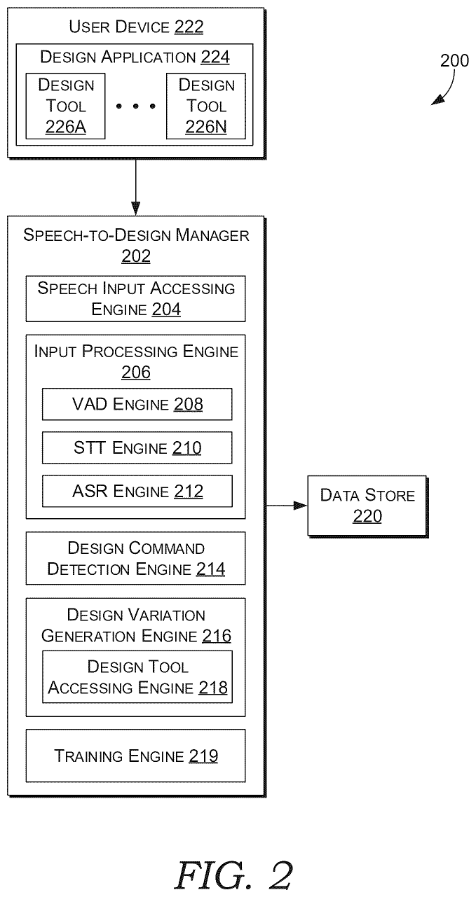

Application 110 operating on user device 102 can generally be any application capable of facilitating the exchange of information between the user device(s) and the speech-to-design manager 108 in generating design variations using design tools (e.g., design tools 226A-226N of FIG. 2) of application 110. In certain embodiments, application 110 is a design application (e.g., design application 224 of FIG. 2). In some implementations, the application(s) comprises a web application, which can run in a web browser, and could be hosted at least partially on the server-side of environment 100. In addition, or instead, the application(s) can comprise a dedicated application. In some cases, the application is integrated into the operating system (e.g., as a service). It is therefore contemplated herein that “application” be interpreted broadly.

In accordance with embodiments herein, the application 110 can facilitate detecting design commands from speech using NLP to generate design variations in an efficient and effective manner. In operation, a user inputs speech, such through a microphone on user device 102, indicating a desired design for application 110. Speech-to-design manager 108 detects parameters of detected design commands mapped to particular design tools of application 110 from a prompt generated based on the speech. Speech-to-design manager 108 causes application 110 to generate design variations that comply with the detected parameters of the detected design commands from the prompt, such as design variations with different layouts, color schemes, content arrangements, and/or the like. The user inputs subsequent speech via user device 102 indicating desired revisions to the design variations displayed via an interface of application 110 on user device 102, such as a selection of particular parameters of the design variations and desired revisions to the design variations. Speech-to-design manager 108 detects parameters of detected design commands mapped to particular design tools of application 110 from a subsequent prompt generated based on the subsequent speech. Speech-to-design manager 108 causes application 110 to generate new design variations based on the design variations that comply with the detected parameters of the detected design commands from the subsequent prompt. After the user reviews the new design variations via an interface of application 110 on user device 102, the design process iteratively continues until the user selects a final design from the generated design variations.

Speech-to-design manager 108 can be or include a server, including one or more processors, and one or more computer-readable media. The computer-readable media includes computer-readable instructions executable by the one or more processors. The instructions can optionally implement one or more components of speech-to-design manager 108, described in additional detail below with respect to speech-to-design manager 202 of FIG. 2.

For cloud-based implementations, the instructions on speech-to-design manager 108 can implement one or more components, and application 110 can be utilized by a user to interface with the functionality implemented on speech-to-design manager 108. In some cases, application 110 comprises a web browser. In other cases, speech-to-design manager 108 may not be required. For example, the components of speech-to-design manager 108 may be implemented completely on a user device, such as user device 102. In this case, speech-to-design manager 108 may be embodied at least partially by the instructions corresponding to application 110.

Thus, it should be appreciated that speech-to-design manager 108 may be provided via multiple devices arranged in a distributed environment that collectively provide the functionality described herein. Additionally, other components not shown may also be included within the distributed environment. In addition, or instead, speech-to-design manager 108 can be integrated, at least partially, into a user device, such as user device 102. Furthermore, speech-to-design manager 108 may at least partially be embodied as a cloud computing service.

Referring to FIG. 2, aspects of an illustrative speech-to-design management system 200 are shown, in accordance with various embodiments of the present disclosure. At a high level, embodiments described herein detecting design commands from speech using NLP to generate design variations by generating initial design based on design commands and corresponding parameters detected from initial input speech and iteratively generating new design variations from the initial design variations based on changes to the parameters of the initial design variations that are detected from subsequent speech.

As shown in FIG. 2, speech-to-design manager 202 includes a speech input accessing engine 204, an input processing engine 206, a design command detection engine 214, a design variation generation engine 216, a training engine 219, and a data store 220. The foregoing components of speech-to-design manager 202 can be implemented, for example, in operating environment 100 of FIG. 1. In particular, those components may be integrated into any suitable combination of user devices 102 and/or speech-to-design manager 108.

Data store 220 can store computer instructions (e.g., software program instructions, routines, or services), data, and/or models used in embodiments described herein. In some implementations, data store 220 stores information or data received or generated via the various components of speech-to-design manager 202 and provides the various components with access to that information or data, as needed. Data store 220 may be embodied as one or more data stores and the information in data store 220 may be distributed in any suitable manner across one or more data stores for storage (which may be hosted externally).

The speech input accessing engine 204 is generally configured to access input speech. The speech input accessing engine 204 can include rules, conditions, associations, models, algorithms, or the like to access input speech. For example, the speech input accessing engine 204 may comprise NLP techniques, statistical model, fuzzy logic, neural network, finite state machine, support vector machine, logistic regression, clustering, or machine-learning techniques, similar statistical classification processes, or combinations of these to access input speech.

The input processing engine 206 is generally configured to generate a prompt based on input speech, input content, preset specifications, previously-generated design variations, and/or the like. The input processing engine 206, and/or any of its subcomponents, can include rules, conditions, associations, models, algorithms, or the like to generate the prompt. For example, the input processing engine 206, and/or any of its subcomponents, may comprise NLP techniques, statistical model, fuzzy logic, neural network, finite state machine, support vector machine, logistic regression, clustering, or machine-learning techniques, similar statistical classification processes, or combinations of these to generate the prompt.

The design command detection engine 214 is generally configured to detect parameters of detected design commands mapped to particular design tools (e.g., design tools 226A-226N) of a design application (e.g., design application 224). The design command detection engine 214 can include rules, conditions, associations, models, algorithms, or the like to detect parameters of detected design commands. For example, the design command detection engine 214 may comprise NLP techniques, statistical model, fuzzy logic, neural network, finite state machine, support vector machine, logistic regression, clustering, or machine-learning techniques, similar statistical classification processes, or combinations of these to detect parameters of detected design commands.

The design variation generation engine 216 is generally configured to generate design variations based on the detected parameters of the detected design commands. The design variation generation engine 216, and/or any of its subcomponents, can include rules, conditions, associations, models, algorithms, or the like to generate the design variations. For example, the design variation generation engine 216, and/or any of its subcomponents, may comprise NLP techniques, statistical model, fuzzy logic, neural network, finite state machine, support vector machine, logistic regression, clustering, or machine-learning techniques, similar statistical classification processes, or combinations of these to generate the design variations.

The training engine 219 is generally configured to train input processing engine 206, design command detection engine 214, and/or design variation generation engine 216. In some embodiments, input processing engine 206, design command detection engine 214, and/or design variation generation engine 216 are pre-trained models. The training engine 219 can include rules, conditions, associations, models, algorithms, or the like to train input processing engine 206, design command detection engine 214, and/or design variation generation engine 216. For example, the training engine 219 may comprise NLP techniques, statistical model, fuzzy logic, neural network, finite state machine, support vector machine, logistic regression, clustering, or machine-learning techniques, similar statistical classification processes, or combinations of these to train input processing engine 206, design command detection engine 214, and/or design variation generation engine 216.

In operation, a user, such as a graphic designer, inputs speech, such through a microphone on the user device 222, indicating a desired design in a design application 224. For example, a user initiates a new design in design application 224, such as by selecting a new project. The user then provides voice commands to specify the desired design via user device 222. In some embodiments, the user also inputs content into design application 224 via user device 222, such as previous designs, images or documents, to assist in generating the desired design.

In certain embodiments, the speech is accessed by a speech input accessing engine 204. For example, the speech input accessing engine 204 implements voice capturing through an API, such as Web Audio API, WebRTC API, and/or the like. In certain embodiments, the speech is then converted to text by input processing engine 206. An example of text that is converted from input speech is shown in design application interface 400 of FIG. 4. As can be understood, a user speaks into a microphone “Create a graduation party flyer applying the University of Sydney's branding guidelines for Sunday May 26^{th} at 6 pm at the Great Hall of the University of Sydney. Include the University of Sydney's phone number.” The speech is converted into text and shown on the interface 400 of a user device.

In certain embodiments, input processing engine 206 uses voice activity detection (VAD) via a VAD engine 208 to distinguish between speech and non-speech segments using any known VAD technique. In certain scenarios, the VAD engine 208 ensures only relevant voice input is processed, thereby increasing computational efficiency in certain instances. In certain embodiments, input processing engine 206 uses speech-to-text (STT) via a STT engine 210 using any known STT technique. In certain embodiments, input processing engine 206 uses automatic speech recognition (ASR) via an ASR engine 212 using any known ASR technique (e.g., VOSK). In certain embodiments, input processing engine 206 uses streaming recognition and incremental decoding techniques to optimize latency in certain instances.

In certain embodiments, input processing engine 206 generates a prompt based on the input speech, input content (e.g., previous designs, input supporting materials, and/or the like), and/or any preset specifications, such as branding guidelines of a business. For example, input processing engine 206 processes the input speech, input content, and/or any preset specifications using a contextual layer that understands the user's design context by leveraging NLP and semantic understanding in order to generate a prompt that sets the context for the design task.

In certain embodiments, a design command detection engine 214 detects parameters of detected design commands mapped to particular design tools (e.g., design tool 226A and design tool 226N) of a design application 224 from a prompt (e.g., based on the input speech, input content, and/or any preset specifications). In certain embodiments, design command detection engine 214 can detect design commands mapped to particular design tools of a design application 224, such as a template selection design command mapped to a template selection design tool of a design application 224, a text design command mapped to a text design tool of a design application 224, a content design command mapped to a content design tool of a design application 224, such as an image selection design command mapped to an image selection design tool of a design application 224, a text-to-image design command mapped to a text-to-image design tool of a design application 224 and/or the like, and/or any design command mapped to a particular design tool of a design application 224.

In certain embodiments, design command detection engine 214 detects parameters of each detected design command. For example, with respect to a detected template selection design command, design command detection engine 214 can detect a parameter indicating the particular type of template, a parameter indicating a particular color scheme for the template, and/or the like from the input speech, input content, and/or preset specifications. With respect to a detected text design command, design command detection engine 214 can detect a parameter indicating the particular textual content for the design, such any text to be including in the design, a parameter indicating the particular typography, such as the arrangement or font for the text to be included in the design, and/or the like from the input speech, input content, and/or preset specifications. With respect to a detected content design command, design command detection engine 214 can detect a parameter indicating a particular prompt for generating content for the design from the input speech, input content, and/or preset specifications.

In certain embodiments, a design command detection engine 214 detects parameters of detected design commands mapped to particular design tools (e.g., design tool 226A and design tool 226N) of a design application 224 from a prompt using an ontological model that maps terminology to particular design tools. For example, a design command detection engine 214 can utilize an ontological model that maps terminology and relationships for particular parameters of particular templates by extracting metadata from templates and terminology from user inputs used to select particular templates and/or particular parameters of particular templates.

In certain embodiments, design command detection engine 214 uses semantic parsing and/or task-oriented dialogue models in order to break up the text converted from the input speech into corresponding design commands and/or parameters. For example, design command detection engine 214 can parse the prompt using a task-oriented dialogue model to detect a design command to select a template type (e.g., poster, resume, flyer, and/or the like) from the prompt, a design command to apply branding (e.g., based on a particular style guide and assets from a particular brand of a business), and a design command to add content based on the prompt.

In certain embodiments, design variation generation engine 216 generates design variations based on the detected parameters of the detected design commands for display in design application 224 via user device 222. The design variation generation engine 216 causes each corresponding design tool (e.g., design tool 226A and design tool 226N) of the detected design commands to apply the detected parameters of the detected design commands to the design variations via a design tool accessing engine 218. In certain embodiments, the design variation generation engine 216 is a rule-based engine that generates different design variations that comply with the detected parameters of the detected design commands by generating design variations with different layouts, color schemes, content arrangements, and/or the like.

An example of design variations generated based on the detected parameters of the detected design commands is shown in design application interface 500 of FIG. 5. As can be understood, parameters of detected design commands (e.g., template, typography, colors, elements & images, and refinement) are detected from the speech converted into text shown on the interface 400 of a user device of FIG. 4. For example, as shown in design application interface 500 of FIG. 5, “a graduation asset pack” set of parameters is detected of a detected element & images selection design command (e.g., mapped to an element & images selection design tool) based on the input prompt indicating a design for a graduation party flyer. Four design variations are generated and displayed via design application interface 500 of a user device based on different combinations of parameters from the “graduation asset pack” set of parameters.

In certain embodiments, after reviewing the design variations in design application 224 via user device 222, a user inputs subsequent speech indicating desired revisions to the design variations. In this regard, the user can provide additional instructions to iteratively tweak or remix the existing variations to adjust elements, such as color, layout, and/or content in order to regenerate new design variations until a desired result is achieved.

In certain embodiments, after reviewing the design variations, a user inputs subsequent speech via user device 222 indicating a selection of particular parameters of the design variations and desired revisions to the design variations in order to generate new design variations. For example, a user may input speech selecting a particular design variation and desired changes to the selected design variation in order to generate new design variations. As another example, a user may input speech selecting parameters of the design variations, such as a first parameter of one design variation and a second parameter of a different one of the design variations, in order to generate new design variations.

In certain embodiments, the subsequent speech is accessed by a speech input accessing engine 204 and converted to text by input processing engine 206. An example of text that is converted from input speech is shown in design application interface 600 of a user device of FIG. 6. As can be understood, a user reviews the design variations generated in design application interface 500 of FIG. 5. As shown in design application interface 600 of FIG. 6, a user speaks into a microphone “Use the template layout from the first variation, the visual elements of the second variation, and the typography from the fourth variation.” The speech is converted into text and shown on the interface 600 of a user device.

In certain embodiments, input processing engine 206 generates a subsequent prompt based on the subsequent speech, the design variations, the input content, and/or any preset specifications. In certain embodiments, design command detection engine 214 detects parameters of detected design commands mapped to particular design tools (e.g., design tool 226A and design tool 226N) of the design application 224 from the subsequent prompt. For example, the design command detection engine 214 detects a design command to select a particular design variation and parameters of design commands corresponding to the desired changes to the selected design variation. As another example, design command detection engine 214 detects selected parameters of detected design commands from the particular design variations.

In certain embodiments, design variation generation engine 216 generates new design variations based on the detected parameters of the detected design commands from the subsequent prompt and the previously-generated design variations for display in design application 224 via user device 222. An example of new design variations generated based on detected parameters of detected design commands from a subsequent prompt is shown in design application interface 700 of FIG. 7. As can be understood, parameters of detected design commands (e.g., template, typography, colors, elements & images, and refinement) are detected from the speech converted into text shown on the interface 600 of a user device of FIG. 6. For example, as shown in design application interface 700 of FIG. 7, the template parameter of the first design variation of design application interface 500 of FIG. 5 is detected for a detected template selection design command (e.g., mapped to a template selection design tool) based on the input speech from design application interface 600 of FIG. 6. Continuing with the example, as shown in design application interface 700 of FIG. 7, the visual elements parameter of the second design variation of design application interface 500 of FIG. 5 is detected for a detected elements & images selection design command (e.g., mapped to an elements & images selection design tool) based on the input speech from design application interface 600 of FIG. 6. Continuing with the example, as shown in design application interface 700 of FIG. 7, the typography parameter of the fourth design variation of design application interface 500 of FIG. 5 is detected for a typography selection design command (e.g., mapped to a typography selection design tool) based on the input speech from design application interface 600 of FIG. 6. As shown in design application interface 700 of FIG. 7, based on the detected parameters of the detected design commands, four new design variations are generated and displayed via design application interface 700 of a user device.

An example of an algorithm for determining the next set of design variations:
Oₙₑₓₜ=f(α, β, O_{current}, γ, δ, ϵ)
   where Oₙₑₓₜ is the next output generated by the process, α is the user input (e.g., text converted from speech input), β is input content (e.g., supporting documents), O_{current} is the current output (e.g., the current generated design variations), γ is the enhanced context (e.g., based on previous designs), δ is the remix and/or edits by the user (e.g., the selections of particular parameters of particular design variations by the user input), and ϵ is the existing capabilities (e.g., as the design commands are based on the particular mapped design tools).

In certain embodiments, after the user reviews the new design variations in design application 224 via user device 222, the design process iteratively continues until the user selects a generated design variation as a final design. The user can then finalize and save the final design in design application 224 via user device 222. For example, the user can select or input speech via user device 222 indicating the design variation to save as the finalized design.

In certain embodiments, the previously generated variations and/or any selection of a particular design variation can be used by training engine 219 to train input processing engine 206, design command detection engine 214, and/or design variation generation engine 216. For example, input processing engine 206 can be trained by training engine 219 for a particular user or a particular brand (e.g., of a business) in order to optimize the generation of the prompt that sets the context for the design task. As another example, design command detection engine 214 can be trained by training engine 219 for a particular user or a particular business in order to optimize semantic understanding of particular design commands. As another example, design variation generation engine 216 can be trained by training engine 219 for a particular user or a particular brand (e.g., of a business) in order to optimize the initial output of the generated design variations based on previously selected design variations.

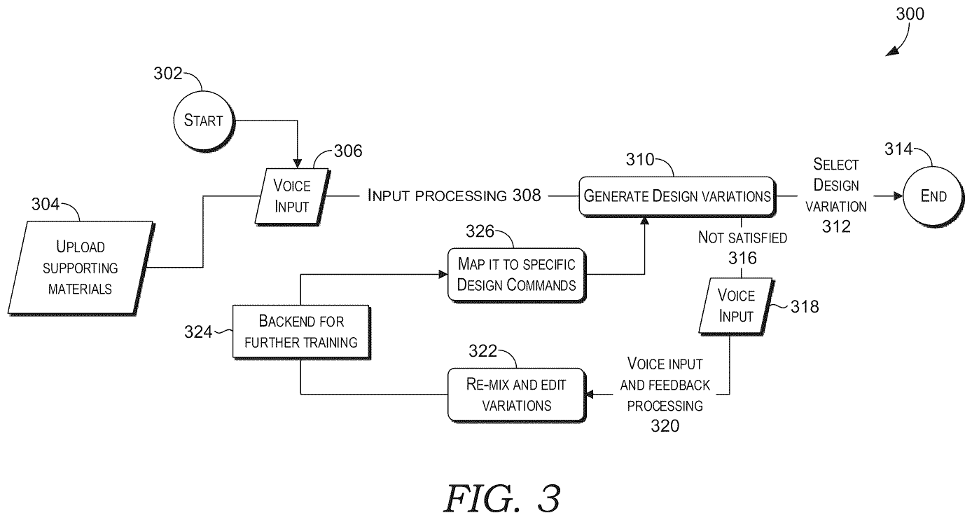

An example diagram 300 of facilitating detecting design commands from speech using NLP to generate design variations is shown in FIG. 3. As can be understood from diagram 300, a user initiates a new design at block 302. The user uploads supporting materials, such as documents, at block 304 and applies voice input at block 306 indicating the desired design. The voice input is processed at block 308 in order to generate design variations at block 310. If the user is satisfied with one of the generated design variations, the user can select a design variation at block 312 and save the finalized design at block 314. If the user is unsatisfied with the design variations at block 316, the user can apply subsequent voice input at block 318 indicating the desired changes to the design variations. At block 320, the voice input is processed with respect to the previously generated design variations to remix and edit the design variations to generate new design variations at block 322. At block 324, the unsatisfactory output of the previously generated variations and/or any selection of a particular design variation can be used to train a model(s) that is used during input processing (e.g., block 308 and block 320) in order to optimize semantic understanding of particular design commands at block 326. For example, the models used during input processing can be trained for a particular user or a particular brand (e.g., of a business) in order to optimize the initial output of the generated design variations based on previously selected design variations. As another example, the models used during input processing can be trained for a particular user or a particular business in order to optimize the semantic processing for mapping prompts to particular parameters of particular design actions. At block 310, new generated variations are generated and the design process can be iteratively repeated until a user selects a variation at block 312 and ends the process at block 314.

### Exemplary Implementations of Detecting Design Commands From Speech Using NLP to Generate Design Variations

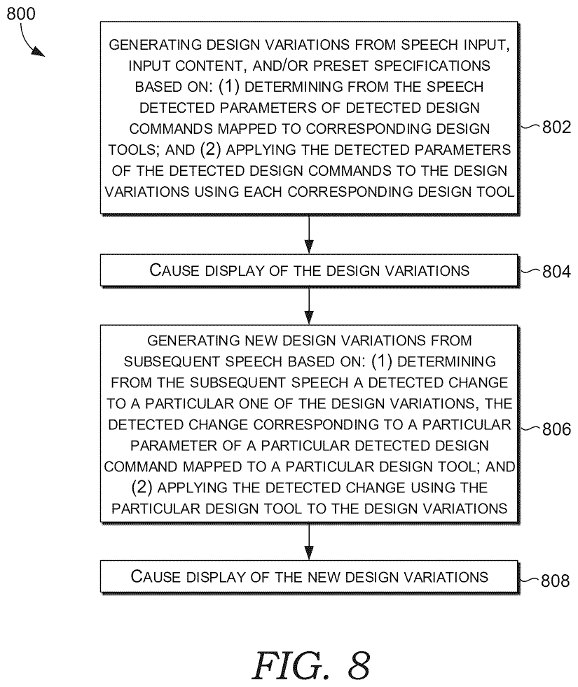

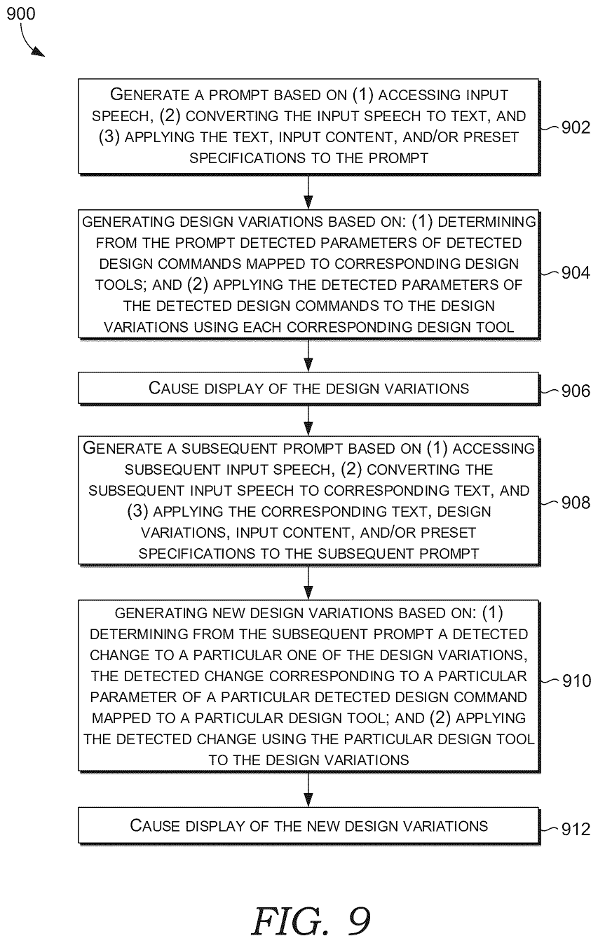

With reference now to FIGS. 8-9, FIGS. 8-9 provide method flows related to facilitating detecting design commands from speech using NLP to generate design variations, in accordance with embodiments of the present technology. Each block of method 800 and 900 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 8-9 are exemplary only and not intended to be limiting. As can be appreciated, in some embodiments, method flows 800-900 can be implemented, at least in part, to facilitate detecting design commands from speech using NLP to generate design variations.

Turning to FIG. 8, a flow diagram 800 is provided showing an embodiment of a method 800 for facilitating detecting design commands from speech using NLP to generate design variations, in accordance with embodiments described herein. Initially, at block 802, a design variation generation engine generates design variations from speech, input content, and/or preset specifications based on: (1) determining from the speech input content, and/or preset specifications, by a design command detection engine that uses natural language processing to detect parameters of design commands, detected parameters of detected design commands mapped to corresponding design tools and (2) applying, by the design variation generation engine, the detected parameters of the detected design commands to the design variations using each corresponding design tool. At block 804, the design variations are displayed via a design application.

In certain embodiments, the speech is accessed by a speech input accessing engine. In certain embodiments, the detected parameters are determined based on: (1) generating a prompt, by an input processing engine, based on converting the speech to text using VAD, STT and ASR and applying the text to the prompt and (2) applying the prompt to the design command detection engine to determine the detected parameters of detected design commands. In certain embodiments, the detected parameters are determined based on: (1) generating a prompt, by an input processing engine, based on converting the speech to text and applying input content and preset specifications to the prompt and (2) applying the prompt to the design command detection engine to determine the detected parameters of detected design commands. In certain embodiments, the detected parameters are determined using an ontological model that maps terminology to the corresponding design tools. In certain embodiments, the detected parameters are determined using semantic parsing to parse a prompt based on the speech and a task-oriented dialogue model to detect design commands after parsing the prompt.

At block 806, the design variation generation engine generates new design variations from subsequent speech based on: (1) determining from the subsequent speech, by the design command detection engine, a detected change to a particular one of the design variations where the detected change corresponds to a particular parameter of a particular detected design command mapped to a particular design tool and (2) applying, by the design variation generation engine, the detected change using the particular design tool to the design variations. At block 808, the new design variations are displayed via the design application.

In certain embodiments, the subsequent speech is accessed by the speech input accessing engine. In certain embodiments, the detected change is determined based on: (1) generating a subsequent prompt, by the input processing engine, based on converting the subsequent speech to subsequent text using VAD, STT and ASR and applying the subsequent text to the subsequent prompt and (2) applying the subsequent prompt to the design command detection engine to determine the detected change. In certain embodiments, the detected change is determined based on: (1) generating a subsequent prompt, by the input processing engine, based on converting the subsequent speech to corresponding text and applying the input content and the preset specifications to the prompt and (2) applying the subsequent prompt to the design command detection engine to determine the detected change. In certain embodiments, the detected change is determined using the ontological model that maps terminology to the corresponding design tools. In certain embodiments, the detected change is determined using semantic parsing to parse a subsequent prompt based on the subsequent speech and the task-oriented dialogue model to detect the change after parsing the prompt.

In certain embodiments, the detected change corresponds to a selection of the particular parameter from the one of the design variations to apply to the design variations. In certain embodiments, the detected change corresponds to a selection of the particular parameter from a different one of the design variations to apply to the particular one of the design variations. In certain embodiments, the detected change corresponds to a first selection of the particular parameter from the one of the design variations to apply to the design variations and a second selection of a different parameter from a different one of the design variations to apply to the design variations. In certain embodiments, input processing engine, design command detection engine, and/or design variation generation engine can be trained using the design variations as training input to optimize semantic understanding of the parameters of the design commands from input speech.

Turning to FIG. 9, a flow diagram 900 is provided showing an embodiment of a method 900 for facilitating detecting design commands from speech using NLP to generate design variations, in accordance with embodiments described herein. Initially, at block 902, an input processing engine generates a prompt based on (1) accessing input speech using a speech input accessing engine, (2) converting the input speech to text, and (3) applying the text, input content, and/or preset specifications to the prompt. In certain embodiments, the speech is converted to text using VAD, STT and ASR.

At block 904, a design variation generation engine generates design variations based on: (1) determining from the prompt, by a design command detection engine that uses natural language processing to detect parameters of design commands, detected parameters of detected design commands mapped to corresponding design tools and (2) applying, by the design variation generation engine, the detected parameters of the detected design commands to the design variations using each corresponding design tool. At block 906, the design variations are displayed via a design application.

In certain embodiments, the detected parameters are determined using an ontological model that maps terminology to the corresponding design tools. In certain embodiments, the detected parameters are determined using semantic parsing to parse a prompt based on the speech and a task-oriented dialogue model to detect design commands after parsing the prompt.

At block 908, the input processing engine generates a subsequent prompt based on (1) accessing subsequent input speech using the speech input accessing engine, (2) converting the subsequent input speech to corresponding text, and (3) applying the corresponding text, design variations, input content, and/or preset specifications to the subsequent prompt. In certain embodiments, the subsequent speech is converted to corresponding text using VAD, STT and ASR.

At block 910, the design variation generation engine generates new design variations based on: (1) determining from the subsequent prompt, by the design command detection engine, a detected change to a particular one of the design variations where the detected change corresponds to a particular parameter of a particular detected design command mapped to a particular design tool and (2) applying, by the design variation generation engine, the detected change using the particular design tool to the design variations. At block 912, the new design variations are displayed via the design application.

In certain embodiments, the detected change is determined using the ontological model that maps terminology to the corresponding design tools. In certain embodiments, the detected change is determined using semantic parsing to parse a subsequent prompt based on the subsequent speech and the task-oriented dialogue model to detect the change after parsing the prompt. In certain embodiments, the detected change corresponds to a selection of the particular parameter from the one of the design variations to apply to the design variations. In certain embodiments, the detected change corresponds to a selection of the particular parameter from a different one of the design variations to apply to the particular one of the design variations. In certain embodiments, the detected change corresponds to a first selection of the particular parameter from the one of the design variations to apply to the design variations and a second selection of a different parameter from a different one of the design variations to apply to the design variations. In certain embodiments, input processing engine, design command detection engine, and/or design variation generation engine can be trained using the design variations as training input to optimize semantic understanding of the parameters of the design commands from input speech.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 10 in particular, an exemplary operating environment for implementing aspects of the technology described herein is shown and designated generally as computing device 1000. Computing device 1000 is just one example of a suitable computing environment and is not intended to suggest any limitation as to the scope of use or functionality of the technology described herein. Neither should the computing device 1000 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 10, computing device 1000 includes a bus 1010 that directly or indirectly couples the following devices: memory 1012, one or more processors 1014, one or more presentation components 1016, input/output (I/O) ports 1018, I/O components 1020, an illustrative power supply 1022, and a radio(s) 1024. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 10 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 10 and refer to “computer” or “computing device.”

Computing device 1000 typically includes a variety of computer-readable media. Computer-readable media can be any available media that can be accessed by computing device 1000 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1012 includes computer storage media in the form of volatile and/or nonvolatile memory. The memory 1012 may be removable, non-removable, or a combination thereof. Exemplary memory includes solid-state memory, hard drives, and optical-disc drives. Computing device 1000 includes one or more processors 1014 that read data from various entities such as bus 1010, memory 1012, or I/O components 1020. Presentation component(s) 1016 present data indications to a user or other device. Exemplary presentation components 1016 include a display device, speaker, printing component, and vibrating component. I/O port(s) 1018 allow computing device 1000 to be logically coupled to other devices including I/O components 1020, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1014 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 1000. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 1000. The computing device 1000 may be equipped with depth cameras, such as stereoscopic camera systems, infrared camera systems, RGB camera systems, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

A computing device may include radio(s) 1024. The radio 1024 transmits and receives radio communications. The computing device may be a wireless terminal adapted to receive communications and media over various wireless networks. Computing device 1000 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

What is claimed is:

1. One or more computer-readable media having a plurality of executable instructions embodied thereon, which, when executed by one or more processors, cause the one or more processors to perform a method comprising:
generating, by a design variation generation engine, design variations from speech based on:
determining from the speech, by a design command detection engine that uses natural language processing to detect parameters of design commands, detected parameters of detected design commands mapped to corresponding design tools; and
applying, by the design variation generation engine, the detected parameters of the detected design commands to the design variations using each corresponding design tool;
generating, by the design variation generation engine, new design variations from subsequent speech based on:
determining from the subsequent speech, by the design command detection engine, a detected change to a particular one of the design variations, the detected change corresponding to a particular parameter of a particular detected design command mapped to a particular design tool; and
applying, by the design variation generation engine, the detected change using the particular design tool to the design variations; and
causing display of the new design variations.

2. The media of claim 1, the method further comprising:
accessing, by a speech input accessing engine, the speech;
determining the detected parameters based on:
generating a prompt, by an input processing engine, based on converting the speech to text using voice activity detection (VAD), speech-to-text (STT) and automatic speech recognition (ASR) and applying the text to the prompt; and
applying the prompt to the design command detection engine to determine the detected parameters of detected design command;
accessing, by the speech input accessing engine, the subsequent speech; and
determining the detected change based on:
generating a subsequent prompt, by the input processing engine, based on converting the subsequent speech to corresponding text using VAD, STT and ASR and applying the corresponding text to the subsequent prompt; and
applying the subsequent prompt to the design command detection engine to determine the detected change.

3. The media of claim 1, the method further comprising:
determining the detected parameters based on:
generating a prompt, by an input processing engine, based on converting the speech to text and applying input content and preset specifications to the prompt; and
applying the prompt to the design command detection engine to determine the detected parameters of detected design command; and
determining the detected change based on:
generating a subsequent prompt, by the input processing engine, based on converting the subsequent speech to corresponding text and applying the input content and the preset specifications to the prompt; and
applying the subsequent prompt to the design command detection engine to determine the detected change.

4. The media of claim 1, the method further comprising:
determining the detected parameters using an ontological model that maps terminology to the corresponding design tools; and
determining the detected change using the ontological model.

5. The media of claim 1, the method further comprising:
determining the detected parameters using semantic parsing to parse a prompt based on the speech and a task-oriented dialogue model to detect design commands after parsing the prompt; and
determining the detected change using semantic parsing to parse a subsequent prompt based on the subsequent speech and the task-oriented dialogue model to detect the change after parsing the prompt.

6. The media of claim 1, wherein the detected change corresponds to a selection of the particular parameter from the one of the design variations to apply to the design variations.

7. The media of claim 1, wherein the detected change corresponds to a selection of the particular parameter from a different one of the design variations to apply to the particular one of the design variations.

8. The media of claim 1, wherein the detected change corresponds to a first selection of the particular parameter from the one of the design variations to apply to the design variations and a second selection of a different parameter from a different one of the design variations to apply to the design variations.

9. The media of claim 1, the method further comprising:
training the design command detection engine using the design variations as training input to optimize semantic understanding of the parameters of the design commands from input speech.

10. A computer-implemented method comprising:
generating, by a design variation generation engine, design variations from speech based on:
converting, by an input processing engine, the speech to text;
determining from the text, by a design command detection engine that uses natural language processing to detect parameters of design commands, detected parameters of detected design commands mapped to corresponding design tools; and
applying, by the design variation generation engine, the detected parameters of the detected design commands to the design variations using each corresponding design tool;
generating, by the design variation generation engine, new design variations from subsequent speech based on:
converting, by an input processing engine, the subsequent speech to corresponding text;
determining from the corresponding text, by the design command detection engine, a detected change to a particular one of the design variations, the detected change corresponding to a particular parameter of a particular detected design command mapped to a particular design tool; and
applying, by the design variation generation engine, the detected change using the particular design tool to the design variations; and
causing display of the new design variations.

11. The computer-implemented method of claim 10, further comprising:
accessing, by a speech input accessing engine, the speech;
determining the detected parameters based on:
generating a prompt, by the input processing engine, based on converting the speech to the text using voice activity detection (VAD), speech-to-text (STT) and automatic speech recognition (ASR) and applying the text to the prompt; and
applying the prompt to the design command detection engine to determine the detected parameters of detected design command;
accessing, by the speech input accessing engine, the subsequent speech; and
determining the detected change based on:
generating a subsequent prompt, by the input processing engine, based on converting the subsequent speech to the corresponding text using VAD, STT and ASR and applying the corresponding text to the subsequent prompt; and
applying the subsequent prompt to the design command detection engine to determine the detected change.

12. The computer-implemented method of claim 10, further comprising:
determining the detected parameters based on:
generating a prompt, by the input processing engine, based on applying the text, input content and preset specifications to the prompt; and
applying the prompt to the design command detection engine to determine the detected parameters of detected design command; and
determining the detected change based on:
generating a subsequent prompt, by the input processing engine, based on applying the corresponding text, the input content and the preset specifications to the prompt; and
applying the subsequent prompt to the design command detection engine to determine the detected change.

13. The computer-implemented method of claim 10, further comprising:
determining the detected parameters using an ontological model that maps terminology to the corresponding design tools; and
determining the detected change using the ontological model.

14. The computer-implemented method of claim 10, further comprising:
determining the detected parameters using semantic parsing to parse a prompt based on the speech and a task-oriented dialogue model to detect design commands after parsing the prompt; and
determining the detected change using semantic parsing to parse a subsequent prompt based on the subsequent speech and the task-oriented dialogue model to detect the change after parsing the prompt.

15. The computer-implemented method of claim 10, wherein the detected change corresponds to a selection of the particular parameter from the one of the design variations to apply to the design variations.

16. The computer-implemented method of claim 10, wherein the detected change corresponds to a selection of the particular parameter from a different one of the design variations to apply to the particular one of the design variations.

17. The computer-implemented method of claim 10, wherein the detected change corresponds to a first selection of the particular parameter from the one of the design variations to apply to the design variations and a second selection of a different parameter from a different one of the design variations to apply to the design variations.

18. The computer-implemented method of claim 10, further comprising:
training the design command detection engine using the design variations as training input to optimize semantic understanding of the parameters of the design commands from input speech.

19. A computing system comprising:
a processor; and
a non-transitory computer-readable medium having stored thereon instructions that when executed by the processor, cause the processor to perform operations including:
causing display of design variations via a design application based on:
accessing, by a speech input accessing engine, speech;
converting, by an input processing engine, the speech to text;
determining from the text, by a design command detection engine that uses natural language processing to detect parameters of design commands, detected parameters of detected design commands mapped to corresponding design tools; and
applying, by the design variation generation engine, the detected parameters of the detected design commands to the design variations using each corresponding design tool; and
causing display of new design variations via the design application based on:
accessing, by the speech input accessing engine, subsequent speech;
converting, by the input processing engine, the subsequent speech to corresponding text;
determining from the corresponding text, by the design command detection engine, a detected change to a particular one of the design variations, the detected change corresponding to a particular parameter of a particular detected design command mapped to a particular design tool; and
applying, by the design variation generation engine, the detected change using the particular design tool to the design variations.

20. The system of claim 19, wherein the detected change corresponds to at least one of (1) a selection of the particular parameter from the one of the design variations to apply to the design variations; (2) a corresponding selection of the particular parameter from a different one of the design variations to apply to the particular one of the design variations; or (3) a first selection of the particular parameter from the one of the design variations to apply to the design variations and a second selection of a different parameter from a different one of the design variations to apply to the design variations.
